(19) United States
(12) Patent Application Publication
(10) Pub. No.: US 2009/0279789 A1
(43) Pub. Date: Nov. 12, 2009

(54) System and Method to Recognize Images

(76) Inventors: Ajay MALIK, Santa Clara, CA (US); Robert PERRI, Bartlett, IL (US)

Correspondence Address: MOTOROLA, INC., 1303 EAST ALGONQUIN ROAD, IL01/3RD, SCHAUMBURG, IL, 60196, US

(21) Appl. No.: 12/117,980

(22) Filed: May 9, 2008

(51) Int. Cl. G06K 9/62

(52) U.S. Cl. 382/209

(57) ABSTRACT

A system to recognize images comprises a mobile device and a server. The mobile device is configured to capture an image. The mobile device is further configured to transmit the image to a network. The server of the network receives the image. The server executes a recognition application to determine at least one match by identifying at least one content of the image by comparing the at least one content with recognition application data.

### FIELD OF THE INVENTION

The present invention relates generally to a system and method to recognize images. Specifically, the application references a new image with a database to determine the recognition.

### BACKGROUND

A user of a mobile unit may encounter people, animals, objects, etc. There may be occasions where the user does not recognize the person, animal, object, etc. or may recognize it but not realize from where the user knows it. For example, the user may have seen a list of missing persons, a picture of a criminal at large, a missing pet poster, etc. However, upon seeing the person, the user may not recall exactly where the user saw the likeness or picture of the person. In certain instances such as seeing a criminal at large or a missing person, it may be critical to readily recognize the person so that proper authorities may be contacted.

### SUMMARY OF THE INVENTION

The present invention relates to a system to recognize images comprising a mobile device and a server. The mobile device is configured to capture an image. The mobile device is further configured to transmit the image to a network. The server of the network receives the image. The server executes a recognition application to determine at least one match by identifying at least one content of the image by comparing the at least one content with recognition application data.

### DESCRIPTION OF THE DRAWINGS

FIG. 1 shows a mobile unit according to an exemplary embodiment of the present invention.

FIG. 2 shows a network in which the mobile unit of FIG. 1 is associated according to an exemplary embodiment of the present invention.

FIG. 3 shows a method for a recognition application according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system that includes a mobile unit (MU) equipped to capture images. The system may further include a server that executes a recognition application using recognition application data. The MU, the recognition application, the captured image, the server, and an associated method will be discussed in further detail below. It should be noted that the use of the MU for the exemplary embodiments of the present invention is only exemplary. The device may also be a stationary device.

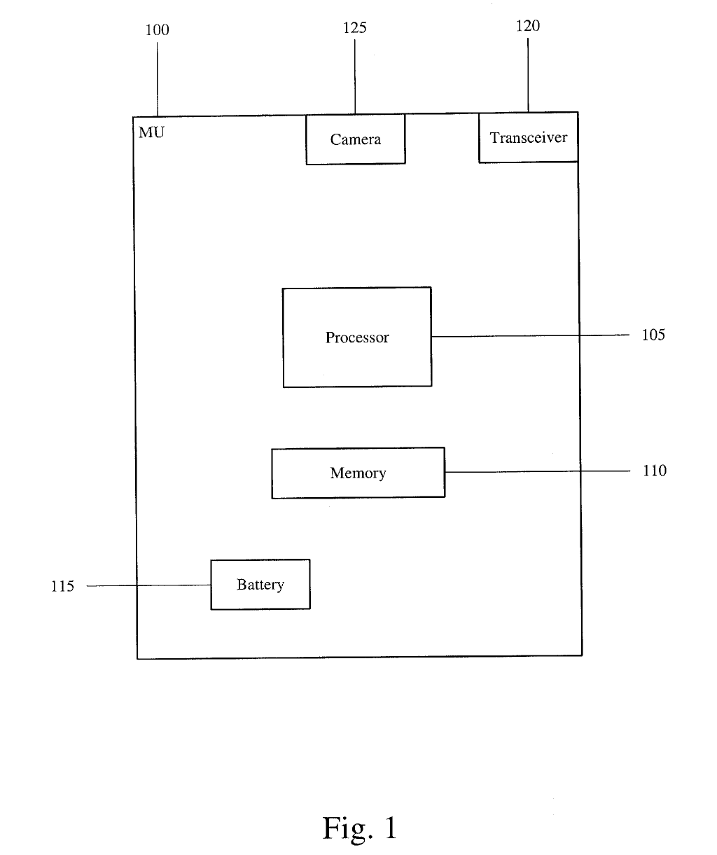

FIG. 1 shows a mobile unit (MU) 100 according to an exemplary embodiment of the present invention. The MU 100 may be any portable electronic device such as a mobile computer, a personal digital assistant (PDA), a laptop, a cell phone, a radio frequency identification reader, a scanner, an image capturing device, a pager, etc. The MU 100 may include a processor 105, a memory 110, a battery 115, a transceiver 120, and an image capturing device such as a camera 125.

The processor 105 may be responsible for executing various functionalities of the MU 100. As will be explained in further detail below, according to an exemplary embodiment of the present invention, the processor 105 may be responsible for packaging an image to be transmitted to a component of a network. The memory 110 may be a storage unit for the MU 100. Specifically, the memory 110 may store images that are captured. The memory 110 may also store data and/or settings pertaining to various other functionalities of the MU 100. The MU 100 may include the battery 115 to supply the necessary energy to operate the MU 100. The battery 115 may be a rechargeable battery such as a nickel-cadmium battery, a lithium hydride battery, a lithium ion battery, etc. It should be noted that the term “battery” may represent any portable power supply that is capable of providing energy to the MU 100. For example, the battery 115 may also be a capacitor, a supercapacitor, etc.

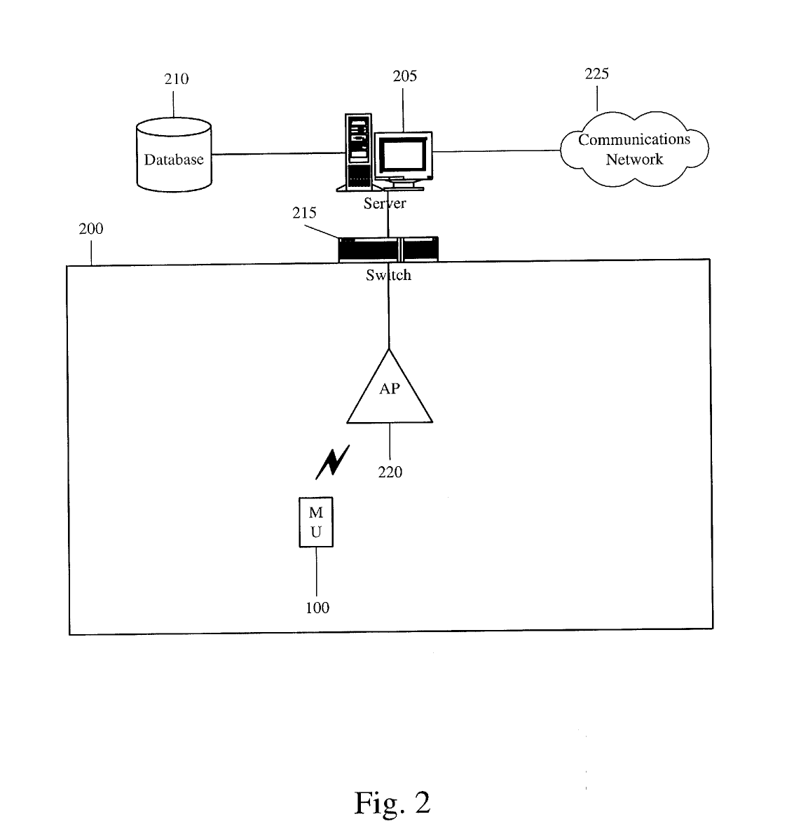

The transceiver 120 may be a component enabling the MU 100 to transmit and receive wireless signals. For example, the transceiver 120 may enable the MU 100 to associate with a wireless network such as a local area network, a wide area network, etc. An exemplary network will be described in detail below with reference to FIG. 2. The transceiver 120 may be configured to transmit an image file created by the processor 105. The transceiver 120 may also be configured to receive data from the network relating to results from a recognition application regarding the transmitted image. The MU 100 may show the results of the recognition application on, for example, a display.

The camera 125 may be any image capturing device. The camera 125 may be, for example, a digital camera. The camera 125 may include components such as a lens, a shutter, a light converter, etc. The image data captured by the camera 125 may be stored on the memory 110. Image data captured by the camera 125 may be processed by the processor 105 to create an image file that may be packaged for transmission via the transceiver 120 to a network so that the recognition application may be run on the image.

FIG. 2 shows a network 200 in which the MU 100 of FIG. 1 is associated according to an exemplary embodiment of the present invention. Specifically, the network 200 may be configured so that the MU 100 may transmit an image file which the recognition application is to be run. The network 200 may include a server 205, a database 210, a switch 215, and an access point (AP) 220. It should be noted that the network 200 is only exemplary. That is, any network architecture may be used.

The server 205 may be configured to be responsible for the operations occurring within the network 200. Specifically, the server 205 may execute the recognition application. The recognition application may include data in which received images from the MU 100 are, for example, compared. The recognition application data may be stored on the database 210. The database 210 may also store the recognition application. The database 210 may store other data relating to the network 200 such as association lists. The network 200 may further include the switch 215 to direct data appropriately.

The network 200 may incorporate the AP 220 to extend a coverage area so that the MU 100 may connect to the network in a greater number of locations. The AP 220 contains an individual coverage area that is part of an overall coverage area of the network. That is, the AP 220 may serve as an intermediary for a transmission from the MU 100 to the server 205. As illustrated, the MU 100 is wirelessly associated with the network 200 via the AP 220. It should be noted that the network 200 may include further APs to further extend the coverage area of the network 200.

According to the exemplary embodiments of the present invention, images captured using the camera 125 may be processed by the recognition application executed on the server 205 by transmitting the captured image to the server 205 via the transceiver 120 of the MU 100 and the AP 220 of the network 200. The server 205 may access the database 210 that stores the recognition application data and determine a result. The result may be forwarded to the AP 220 to be transmitted back to the MU 100 via the transceiver 120. The result may indicate that no match was found. A “no match” message may be shown to a user on the display. If at least one match is found between the image and the database of the recognition data, the match(es) may be shown to the user on the display. The match(es) may indicate an identity, a location, and other pertinent information relating to the match.

The recognition application may determine a match using any known recognition criteria. In a first exemplary embodiment for determining a match for a person, facial features may be used as a determinant. For example, spatial orientations of eyes, a nose, a mouth, ears, eye brows, etc. may be used as a basis. In a second exemplary embodiment for determining a match for a person, when the camera 125 is capable of capturing color images, features of the person including colors may be used such as eye color, hair color, skin tone, eye brow color, lip color, etc. With regard to determining a match for an animal such as a lost pet, colors, facial features, body types, sizes, etc. may be used as a basis.

The recognition application may enable a user to narrow a search field of the database of recognition data. For example, the MU 100 may include a user interface such as a keypad, a touch screen display, etc. The user may enter a description of contents included in the image captured by the camera 125. The user may start an application program of the MU 100 that is part of the recognition program of the server 205. An image captured by the camera 125 and stored in the memory 110 may be accessed and uploaded to the application program. The application program may include at least one input field in which the user may enter a description. The fields may include choices that affect subsequent fields. For example, an initial input field may be a general field indicating a type of the contents of the image such as a person, an animal, an object, etc. A subsequent input field may be a more detailed input field. For example, if the initial input field indicates a person, then the subsequent input field may request a gender of the person, a race of the person, identifying features of the person, etc. In another example, if the initial input field indicates an animal, then the subsequent input field may request a type of animal, a color of the animal, etc. Once the input fields have been entered, these parameters may be transmitted with the captured image to the server 205 so that when the recognition application is executed thereon, a narrower search may be conducted with the recognition application data stored on the database 210.

As discussed above, if a match results from executing the recognition application, the results are transmitted to the MU 100. The results may indicate an identity, a source of the match, and any other pertinent information. For example, if a match is found for a person, a name of the person may be shown to the user on the display of the MU 100. In addition, if a source is associated with the name, then the source may be shown as well. For example, the source may be a list of missing persons or a wanted poster, then this information may be shown to the user. In this example, the MU 100 may be enabled to also show a contact number for proper authorities that was part of the results determined by the server 205. If the MU 100 is equipped with communications devices (e.g., the transceiver 120 is further equipped for communications), then the MU 100 may automatically dial or dial upon request the contact number. The MU 100 may be equipped with further communications options. For example, if the match relates to a criminal at large, then a “panic” button may be available. The panic button may transmit information about the match, location data of the MU 100, a time stamp, etc. to the proper authorities. The authorities may then act accordingly to apprehend the criminal.

In another example, if a match is found for an animal, a name of the animal may be shown to the user on the display. If the animal is a missing animal, contact information such as the animal's owner, a phone number, and/or address may be shown with the name of the animal so that the user may contact the owner of the animal.

The location data of the MU 100 may be determined in a variety of manners. For example, the location data may be determined using a triangulation, a received signal strength indication (RSSI), a global positioning system (GPS), etc. In a first exemplary embodiment, the MU 100 may be equipped to determine the location data. In a second exemplary embodiment, the MU 100 may received the location data by, for example, transmitting signals including parameters related to the MU 100 (e.g., signal strength). The MU 100 may be associated with another network in which the location of the MU 100 is determined. In a third exemplary embodiment, the network 200 may be used to determine the location. For example, when the MU 100 transmits the image to the server 205, the server 205 may also determine the location of the MU 100 along with executing the recognition application.

The server 205 may further be connected to a communications network 225. The recognition application data stored on the database 210 may be limited or may be out of date. While executing the recognition application, outside sources may be accessed through the communications network 225 when the server 205 is unable to find a match for the image using the recognition application data stored on the database 210. The server 205 and also the AP 220 and/or the MU 100 may communicate with the communications network 225 using, for example, GPRS, WIMAX, 3G networks, etc.

The communications network 225 may also include a gateway in which a communication is transmitted onto other networks. The connection to the gateway via the communications network 225 enables the server 205 to make contact to a respective agency. For example, if the match that is determined from the transmitted image indicates that a person is a missing person or a criminal at large, the server 205 may contact the proper authorities. The server 205 may transmit, for example, the match, the source data, the location data of the MU 100, etc. The server 205 may also be equipped to receive instruction from the user of the MU 100. Thus, if the user receives the match and the match indicates that the identity of a person in the image is a missing person or a criminal at large, the user may send a signal to the server 205 to contact the proper authorities.

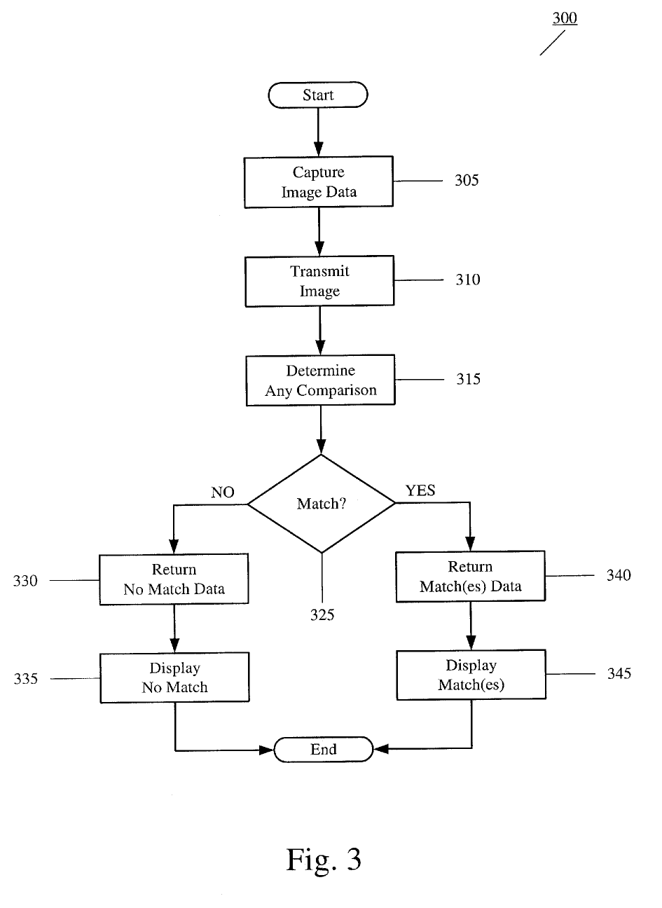

FIG. 3 shows a method 300 for the recognition application according to an exemplary embodiment of the present invention. The method 200 will be described with reference to the MU 100 of FIG. 1 and the network 200 of FIG. 2.

In step 305, an image is captured. As discussed above, the image data may be captured using the camera 125. The image may be captured as a black and white photograph or may be captured as a color photograph. An image file may be created by the processor 105. The image file may be stored on the memory 110. In step 310, the image file may be transmitted to the database 210 of the network 200 through the server 205 of the network 200 via the transceiver 120 of the MU 100 and the AP 220 of the network 200. As discussed above, other data such as from the input fields of the application program may be transmitted as well with the image.

In step 315, a determination is made whether the image captured in step 305 has a match by the server 205 executing the recognition application. The determination may be made through a comparison of the image with the recognition application data stored in the database 310.

As discussed above, the determination may entail a comparison of features captured in the image with features associated with the recognition data. The recognition data may be stored as selected features of the person, animal, or object. Thus, a match of the selected features to the person, animal, or object may result in a match. A match may be determined if a predetermined number of the selected features are identified in the captured image. For example, if at least 80% of the selected features are contained in the captured image, the recognition application may determine that a match results. Accordingly, more than one match may result from the determination. However, if the image contains less than 80% of any of the selected features for each person, animal, or object of the recognition data, no match may result.

In step 320, a determination is made if a match resulted from the comparison in step 315. If no match is found, the method 300 continues to step 325 where a “no match found” result is transmitted from the server 205 via the AP 220 to the MU 100. Subsequently, in step 330, the “no match found” result is displayed on the MU 100 to the user. If at least one match is found, the method 300 continues to step 335 where match(es) are transmitted from the server 205 via the AP 220 to the MU 100. Subsequently, in step 340, the at least one match is shown to the user on the display of the MU 100.

Whether the method goes to step 330 or step 340, the analysis of the comparison may be shown to the user along with the actual result. That is, when “no match found” is shown, the top five results may be given to the user despite the results not including the requisite predetermined threshold number of selected features. Each result may be given in an order from a highest commonality (i.e., as close to the predetermined threshold) to a lowest commonality. When at least one match is found, a substantially similar analysis may be shown. For example, if a result has a 95% match to the selected features, this result may be given with the percentage commonality. Another result having an 85% match to the selected features may be given with this percentage commonality as well. Further matches may be given where some of the matches may be for a person, an animal, or an object that falls under the predetermined threshold (e.g., less than 80% match to the selected features).

The method 300 may further include a step where the authorities may be contacted through the server 205. For example, upon the match being determined in step 320, a subsequent step between step 320 and step 335 is to determine if the match is of urgency such as a missing person or a criminal at large. The server 205 may transmit the match, the location data of the MU 100, the source data from which the match was determined, etc. to the proper authorities. In another example, the user of the MU 100 may view the matches at step 340 and instruct the server to contact the authorities.

It should be noted that the method 300 may include additional steps. For example, as discussed above, after step 305, an additional step may be included where the user enters the input fields to narrow the search for a match performed in step 315. In another example, a determination may be made where the match was located. Thus, if the match was from a list of missing persons, a subsequent step after step 340 may include dialing a contact number associated with the list of missing persons. If the match was from a list of criminals at large, a subsequent step after step 340 may include dialing the proper authorities and transmitting the image with other relevant data such as a location of the MU 100, a time stamp of when the image was captured by the camera 125, etc.

It should be noted that the exemplary embodiments of the present invention may be used for other purposes. For example, a user may not know what an object is. When the object is captured in the image, an analysis of the object may be used to identify the object and let the user know what the object is. In another example, the recognition application may be used for personal use. In such an embodiment, a personal recognition application may be executed on the processor 105 of the MU 100. When used for personal use, personal recognition application data may be stored on the memory 110 and updated by the user. Thus, the personal recognition application data may relate to only information that the user knows or wants to know. The personal recognition application may be executed in a substantially similar manner as was executed on the server 205. Personal use may include being able to identify a person that the user has met before (i.e., not necessarily to identify missing persons or criminals at large). The user may be able to recognize a face of a person but not readily recognize who the person is, the name of the person, where the user has met the person before, etc. The personal recognition application may be used to provide this type of information to the user.

Those skilled in the art will understand that the above described exemplary embodiments may be implemented in any number of manners, including, as a separate software module, as a combination of hardware and software, etc. For example, the recognition application may be a program containing lines of code that, when compiled, may be executed on the server 205.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a mobile device configured to capture an image, the mobile device further configured to transmit the image to a network; and
a server of the network receiving the image, the server executing a recognition application to determine at least one match by identifying at least one content of the image by comparing the at least one content with recognition application data.

2. The system of claim 1, wherein an indication of the at least one match is transmitted to the mobile device.

3. The system of claim 1, wherein the match results from the at least one content including common features to a known content.

4. The system of claim 3, wherein the common features exceed a predetermined threshold amount of known features of the known content.

5. The system of claim 1, wherein the at least one content is one of a person, an animal, and an object.

6. The system of claim 2, wherein the indication includes contact data.

7. The system of claim 6, wherein the mobile device comprises a communications functionality configured to communicate based on the contact data.

8. The system of claim 7, wherein the mobile device transmits location data with the indication based on the contact data.

9. The system of claim 8, wherein the location data is determined using at least one of a triangulation, a received signal strength indication, and a global positioning system.

10. The system of claim 1, wherein the mobile device comprises a user interface for entering data relating to the image into input fields.

11. A method, comprising:
capturing an image;
transmitting the image; and
receiving an indication of at least one match, the at least one match being determined with a recognition application by identifying at least one content of the image by comparing the at least one content with recognition application data.

12. The method of claim 11, wherein the match results from the at least one content including common features to a known content.

13. The method of claim 12, wherein the common features exceed a predetermined threshold amount to known features of the known content.

14. The method of claim 11, wherein the at least one content is one of a person, an animal, and an object.

15. The method of claim 11, wherein the indication includes contact data.

16. The method of claim 15, further comprising:
communicating the indication based on the contact data.

17. The method of claim 16, further comprising:
communicating location data with the indication based on the contact data.

18. The method of claim 11, further comprising:
receiving data relating to the image into input fields.

19. The method of claim 18, wherein the at least one match is determined using the recognition application data and the data relating to the image.

20. A system, comprising:
an image capturing means for capturing an image, the image capturing means configured to transmit the image to a network; and
a determining means that receives the image for determining at least one match by identifying at least one content of the image by comparing the at least one content with known data.
